(19) United States
(12) Patent Application Publication
(10) Pub. No.: US 2018/0143045 A1
(43) Pub. Date: May 24, 2018

(54) SYSTEMS AND METHODS FOR NON-INTRUSIVE STRAIN TESTING OF STRUCTURAL TOWERS

(71) Applicant: Wind Tower Technologies, LLC, Boulder, CO (US)

(72) Inventor: Matthew J. Chase, Boulder, CO (US)

(73) Assignee: Wind Tower Technologies, LLC, Boulder, CO (US)

(21) Appl. No.: 15/821,567

(22) Filed: Nov. 22, 2017

Related U.S. Application Data
(60) Provisional application No. 62/425,448, filed on Nov. 22, 2016.

(51) Int. Cl. G01D 11/30; G01B 21/32; G01D 11/24

(52) U.S. Cl. CPC G01D 11/30; G01B 2210/58; G01D 11/245; G01B 21/32

(57) ABSTRACT

An apparatus includes a strain gauge and a magnetic attachment system connected to the strain gauge for evaluating bending strains on vertical tower systems.

### RELATED APPLICATIONS

This application claims the benefit of priority under 35 U.S.C. § 119 of U.S. Provisional Application Ser. No. 62/425,448 filed on 22 Nov. 2016, titled Systems and Methods for Non-Intrusive Strain Testing of Structural Towers; the entire content of which is hereby incorporated by reference in its entirety.

### BACKGROUND

A wind turbine tower often supports a turbine that is used to convert wind energy into rotational energy. The turbine generally includes three or more blades that move as the wind passes by. The blades are arranged to rotate a shaft of a motor located in the turbine's nacelle unit located at the top of the tower.

As the wind blows against the turbine blades, the wind also blows against the tower, which provides a bending force on the wind turbine tower. Additional lateral loads are imposed on the wind turbine tower due to the mechanical resistance of the turbine's blades to rotation. Thus, wind and other forces can impose lateral loads on wind turbine towers. These forces are not necessarily constant. As the wind speed fluctuates, the lateral loads on the wind turbine can vary. Fatigue and other modes of mechanical failure can be induced by these varying lateral loads.

### SUMMARY

In some examples, an apparatus includes a strain gauge and a magnetic attachment system connected to the strain gauge.

The magnetic attachment system can include a first magnet and a second magnet spaced apart from the first magnet at a distance. In some cases, when the first magnet and the second magnet are magnetically attached to a magnetized object, the strain gauge measures a mechanical strain in the magnetized object.

The magnetic attachment system can include a rare earth metal.

The apparatus can further include a housing and a recess defined in the housing. The strain gauge can be disposed within the recess.

The strain gauge can include a length, a first portion of the length, and a second portion of the length.

The magnetic attachment system can include a first magnet attached to the housing that corresponds to the first portion of the length of the strain gauge. The magnetic attachment system can also include a second magnet attached to the housing that corresponds to the second portion of the length of the strain gauge. The second magnet can be spaced apart from the first magnet at a distance along the length of the strain gauge.

The apparatus can include a transmitter, a receiver, a router, a power source, a communications system, or combinations thereof in electronic communication with the strain gauge. In some cases, the communication system can operate on a standard communication protocol.

In some instances, a handle is attached to the housing.

In another embodiment, a method for using an apparatus includes securing a strain gauge to a magnetized object with a first magnet and a second magnet spaced apart from the first magnet at a distance and the first magnet corresponding with a first portion of a length of the strain gauge and the second portion corresponding with a second portion of the length of the strain gauge, and generating a measurement of strain in the magnetized object between the first magnet and the second magnet.

The method can further include wirelessly transmitting the measurement while the strain gauge is secured to the magnetized object.

Wirelessly transmitting the measurement includes sending the measurement over a standard communication protocol.

The magnetized object can be a tower, a monopole, a lattice, a beam, a wall, a wind turbine blade, a solar panel, a drive shaft, an automobile, an aircraft, a wing, another type of structure, or combinations thereof

The first magnet and the second magnet can include a rare earth metal.

The first magnet and the second magnet can be permanent magnets.

The measurement can be up to a 95 percent accurate representation of the strain in the magnetized object between the first magnet and the second magnet.

In another embodiment, an apparatus include a housing, a recess defined in the housing, and a strain gauge is disposed within the recess. The strain gauge can include a length, a first portion of the length, and a second portion of the length. A magnetic attachment system of the apparatus can be connected to the housing. The magnetic attachment system can include a first magnet attached to the housing that corresponds to the first portion of the length of the strain gauge, and a second magnet attached to the housing that corresponds to the second portion of the length of the strain gauge. The second magnet is spaced apart from the first magnet at a distance along the length of the strain gauge. The apparatus includes a transmitter in electronic communication with the strain gauge.

### BRIEF DESCRIPTION OF THE DRAWINGS

FIG. 1 depicts an example of a strain gauge attached to a magnetized object in accordance with aspects of the present disclosure.

FIG. 2 depicts a block diagram of an example of an apparatus containing a strain gauge in accordance with aspects of the present disclosure.

FIG. 3 depicts an example of a wind turbine tower in accordance with aspects of the present disclosure.

FIG. 4 depicts an example of a monopole in accordance with aspects of the present disclosure.

FIG. 5 depicts an example of a method of measuring strain in accordance with aspects of the present disclosure.

FIG. 6 depicts an example of a method of measuring strain in accordance with aspects of the present disclosure.

### DETAILED DESCRIPTION

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. Often, the width of an object is transverse the object's length.

Wind towers are subject to fatigue and other mechanical failure modes due to varying wind loads and other forces. To prevent a wind tower from experiencing these types of failures or to determine what the magnitude of these loads are, the strains in the wind towers are sometimes measured along the length of the wind tower. Conventionally, a strain gauge is attached to the outer surface of the wind turbine by grinding the outer or inner surface of the wind tower to remove paint and/or other coatings. The strain gauge is then conventionally attached to the wind tower by adhesive or by welding the strain gauge to the surface of the wind turbine. One advantage to using welds to secure the strain gauge to the tower is a firm connection that allows for the strain gauge to measure a highly accurate amount of strain in the tower. However, the practice of grinding the tower itself and welding the strain gauge to the tower removes material from the tower and forms holes in the tower's surface. The resulting holes in the wind tower's surface coating ruins the tower's paint job, and exposes the wind tower to corrosion through oxidation, rain, and other types of exposure.

The principles described in the present disclosure include attaching a strain gauge to the outside of an iron based or other magnetizable object, such as a wind tower, a monopole, a lattice structure, a beam, a cantilever, another type of structure, or combinations thereof, with magnets. In some cases, the magnets are high power magnets, such as magnets using rare earth metals or electro magnets. The magnets can attach the strain gauge to the tower without making holes in the tower's outer surface and without ruining the tower's paint or other type of coatings. While the incorporation of the magnets may cause the strain measurements recorded by the strain gauges to be slightly less accurate when compared to the measurements of the strain gauges welded to the outer surface of the tower, the minimal reduction in accuracy is acceptable in many situations. Thus, the principles described herein are directed to making slightly less accurate measurements than are typically obtained in the industry where high precision measurements are desired. Rather, the principles described herein are believed to provide a mechanism for obtaining a ball-park estimate of the strain in the magnetized object. In some cases, the strain measurements resulting from attaching the strain gauge with magnets is up to 95 percent accurate, or more. In other cases, the strain measurements resulting from attaching the strain gauge with magnets is up to 90 percent accurate. In yet other cases, the strain measurements resulting from attaching the strain gauge with magnets is up to 85 percent accurate. In even other examples, the strain measurements resulting from attaching the strain gauge with magnets is up to 80 percent accurate. Further, the strain measurements resulting from attaching the strain gauge with magnets can be approximately 75 percent accurate.

While the strain measurements can be less accurate, the obtained strain measurements can be sufficient to indicate whether a magnetized object is experiencing a threshold amount of strain that merits a more precise measurement. For example, if the magnetized object is determined to need replacement or the attachment of a reinforcement member when the object experiences strain of over 10 percent, the strain gauge can be attached to the object with magnets to determine if a more precise tests should be done to obtain a more accurate reading. In a hypothetical example, the strain gauge with the magnets can be determined to be 90 percent accurate. In this example, if the strain gauge measures that the magnetized object experiences a strain of 5 percent, then a user can conclude that the magnetized object is not experiencing the threshold strain amount of 10 percent because +/−90 percent of 5 provides a range of 4.5 to 5.5. Thus, the user can conclude that no additional tests are needed even with a less accurate reading.

Attaching the strain gauge to the outer surface of a magnetized object is quicker than bolting the strain gauges to the object. As a result, the strain measurements can be obtained much quicker. In examples where a user is determining the strain experienced in each tower of a windfarm, the user can relatively quickly attach the strain gauge through the use of magnets to obtain the readings from each of the towers.

The strain gauge can be contained in a single unitary measurement apparatus. In some examples, the apparatus also includes a transmitter, a receiver, memory, a processor, communication protocol policies, an operating system, a power source, a display, a user input mechanism, a router, other electronic components, or combinations thereof. The apparatus can be in communication with a remote device, like a mobile device, or a device that is located away from the testing site. Instructions to record the measured strain can be received by the apparatus. Further, the apparatus can cause the processor to send recorded strain measurements in response to a request or automatically without a request. The recorded measurements can be sent at intervals, sent continuously, sent on demand, sent based on another protocol, or combinations thereof. The recorded measurements can be sent over a communications network based on communication standards.

In some examples, the communications standards include cellular communication protocols directed towards transmitting data with mobile devices, cell coverage, and roaming. Some common cellular communication protocols include base station management application part protocols, base station subsystem management application part protocols, base station subsystem application part protocols, direct transfer application part protocols, short message service transfer layer protocols, base transceiver station management protocols, and mobile application part protocols. The communications standards can include communication protocols for interfacing with the local, private and public networks in the area where testing occurs. Some examples of these are local area networks, metropolitan area networks, wide area networks and the Internet. These protocols can include transmission control protocols, Internet protocols, file transport protocols, hyper-text transfer protocols, post office protocols, simple mail transfer protocols, dynamic host control protocols, border gateway protocols, unified datagram protocols, real time protocols, and reservation control protocol.

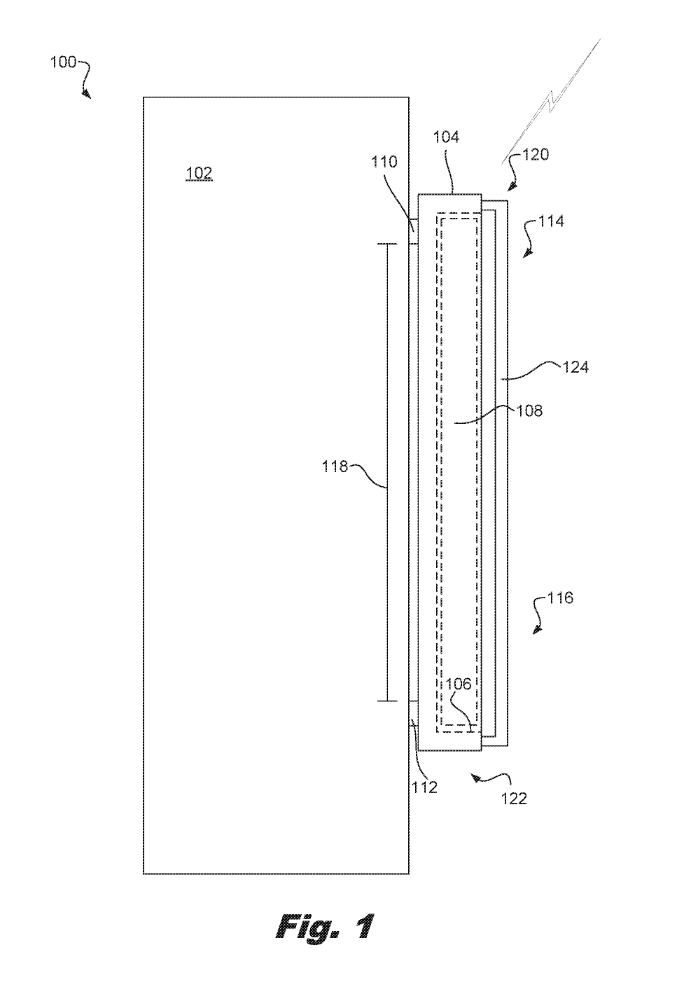

FIG. 1 depicts an example of an apparatus 100 connected to a magnetized object 102. In this example, the apparatus 100 includes a housing 104, a recess 106 defined in the housing 104, a strain gauge 108 disposed in the housing 104, a first magnet 110 connected to the housing 104, and a second magnet 112 connected to the housing 104. The first magnet 110 and the second magnet 112 attach the housing 104 to the magnetized object 102.

The housing 104 can be attached to the magnetized object 102 by placing the first magnet 110 and the second magnet 112 adjacent to the magnetized object 102. The magnetic fields of the first magnet 110 and the second magnet 112 are directed so that the magnetized object 102 is attracted to the magnets. As a result, the first magnet 110 and the second magnet 112 attach the housing 104 to the magnetized object 102.

The first magnet 110 can be attached to the housing 104 in a region that corresponds with a first portion 114 of a length of the housing 104. The second magnet 112 can be attached to the housing 104 in another region that corresponds with a second portion 116 of a length of the housing 104. The second magnet 112 can be spaced apart at a distance 118 from the first magnet. In some examples, the first magnet 110 is located at a first end 120 of the housing 104, and the second magnet 112 is located at a second end 122 of the housing 104 that is opposite the first end 120. The distance between the first and second magnets can correspond to the length of the magnetized object that is tested for strain. For example, if the first magnet 110 and the second magnet 112 are seperated from one another at a distance of three feet, then the strain gauge can test the magnetized object for strain corresponding to that three feet.

The first and second magnets can be spaced apart at any appropriate distance. In some examples, the first and second magnets are spaced apart within 30 feet of one another. In another example, the distance is within 20 feet. Further, the distance can be within 15 feet. In another example, the distance is within 10 feet. In yet another embodiment, the distance is within 5 feet. In some cases, the distance is within 2 feet. In yet another example, the distance is less than a foot. In an additional example, the distance is less than 6 inches. In another example, the distance can be less than 1 inch.

Each of the first and second magnets can be fixed points where the magnetized object is fixed to the strain gauge 108. In the example of FIG. 1, the housing 104 is rigidly attached to the strain gauge 108 and the magnetized object 102. In this example, as the magnetized object bends, the compression and tensile stresses are transferred to the housing 104 through the first and second magnets. Thus, the housing 104 bends with a corresponding compressive and tensile loading from the bending forces experienced in the magnetized object 102. The strain gauge 108 can also be attached to the housing 104 such that portions of the strain gauge 108 are attached to the inside surface of the housing's recess 106 at locations that correspond to the location of the magnets. In some cases, the portions of the strain gauge 108 between these rigid connections are floating so that they do not contact a surface of the housing's recess 106. In this manner, the only forces affecting the strain gauge's measured reading are applied at the points where the strain gauge 108 is rigidly attached to the recess 106.

In this example, the housing 104 is depicted with a handle 124. The user can move the apparatus 100 with the handle 124. In alternative examples, the apparatus 100 does not include a handle 124.While this example has been described with the strain gauge being secured to the magnetized object with a housing, in other examples no housing is used. In these types of examples, the magnets can be directly attached to the strain gauge.

In some examples, the first magnet 110 and the second magnet 112 are permanent magments. However, any appropriate type of magnet can be used. For example, a non-exhaustive list of magnet types that can be compatible with the principles described herein include permanent magnets, temporary magnets, electromagnets, other types of magnets, or combinations thereof

For the purposes of this disclosure, permanent magnets generally refer to those devices that maintain a level of magnetism once they are magnetized. These magnets can be attached the outside of the housing so that the magnets are between the housing and the magnetized object when the housing is secured to the magnetized object.

Further, for the purposes of this disclosure, temporary magnets generally refer to those magnets that act like permanent magnets when they are within a strong magnetic field, but lose their magnetism when the magnetic field disappears. In some cases, the housing itself can include at least a region that includes a temporary magnetizable material. In this case, a permanent magnet can be placed within the housing's main recess or in a secondary recess that causes the housing (or at least a portion of the housing) to generate a magnetic field for attachment to the magnetized object. In yet another example, the components of an electromagnet can be positioned within the housing and activated as desired to cause the housing (or least a portion of the housing) to generate the magnetic field for attachment. In examples where at least a portion of the housing includes a temporary magnetizable material, the gap between the housing and the magnetizable object can be more precisely controlled. In some applications, the materials that make up a permanent magnet can require a large volume to generate the magnetic strength desired for attaching to the magnetizable object such that the gap is larger than desired. In these situations, making at least a portion of the housing out of a temporarily magnetizable material provides an advantage in that the primary magnetic source can be as large as desired without affecting the gap size.

For the purposes of this description, an electromagnet generally refers to a wound helical coil of wire, usually with an iron core, which acts like a permanent magnet when current is flowing in the wire. The strength and polarity of the magnetic field created by the electromagnet are adjustable by changing the magnitude of the current flowing through the wire and by changing the direction of the current flow.

The first magnet can be part of a group of magnets that are attached to a portion of the housing and/or strain gauge, such as a first end of the housing. For example, a group of magnets can be attached in a row to the end of the housing along the housing's width. Likewise, the second magnet can be part of a group of magnets that are attached to another portion of the housing and/or strain gauge, such as a second end of the housing. In other examples, the first magnet is part of a group of magnets that form multiple rows. Likewise, the second magnet is part of a group of magnets that form multiple rows. Within these groups that correspond with the first and second magnets, the magnets can each have an equal magnetic strength. But, in other examples, the magnetic field strength can vary between the magnets within each of the groups. In other examples, just a single magnet is used at each of the ends of the housing and/or strain gauge.

Further, the first and second magnet can include any appropriate type of shape. A non-exhaustive list of shapes of the magnets can include bars, cubes, round bars, rectangular bars, horseshoes, rings, disks, rectangles, multi-fingered rings, other shapes, or combinations thereof. In some cases, the magnets include flat surfaces that engage the magnetizable object. In other examples, the magnets are contoured to match the profile of the magnetizable object's outside surface. For example, if the magnetizable object has a generally cylindrical shape, the magnet can include a generally concave surface that complements the magnetizable object's outer surface.

The magnets can be made of any appropriate type of material. In some examples, the magnets are permanent magnets that are made of rare earth metals. A non-exhaustive list of magnetic materials that can be compatible with the principles described herein include neodymium iron boron, samarium cobalt, alnico, ferrite, metals of the lanthanide series of the periodic table of elements, other types of materials, or combinations thereof. The neodymium iron boron and the samarium cobalt magnets are generally known as rare earth magnets since their compounds include rare earth metals. The magnets can be made by casting them in a mold and grinding. Others magnets can be made by pressing a powder in a mold, pressure bonding, sintering, or methods, or combinations thereof

For purposes of this disclosure, a strain gauge generally refers to a class of sensors that can be used to measure an elastic deformation of an object. Any appropriate type of strain gauge can be used in accordance with the principles described herein. For example, the strain gauge can include a mechanical gauge, an optical gauge, an acoustic gauge, a pneumatic gauge, a diffused semiconductor strain gauge, a bonded resistance strain gauge, or an electrical gauge. Electronic gauges can be capacitance-based, inductance-based, photoelectric-based, wire-type, semiconductor type, thin film type, or combinations thereof

Photoelectric gauges can use a light beam and a photocell detector to generate an electrical current proportional to strain. A photoelectric gauge can be as short as 1/16 inch. Thus, a photoelectric strain gauge can be used in applications where it desirable that the apparatus has a short length.

The metallic foil-type strain gauge can include at least one wire filament. In some cases, the wire filament is approximately 0.001 in thickness and bonded to the surface with a layer of epoxy resin. In some examples, the surface is a surface of the housing's recess. In other examples, the surface is a platform that can connect directly or indirectly to the first and second attachment magnets. When a load is applied to the surface, the surface experiences a change in length. This resulting change in length changes the electrical resistance of the wire. This electrical resistance can be measured, recorded, and correlated with the change in the object's length (strain).

Semiconductor strain gauges include a material that exhibits piezoresistive characteristics. These materials can include silicon, germanium, another type of semiconductor material, or combinations thereof. Thus, the material's electrical resistance changes as the material experiences changes in strain. Accordingly, a strain measurement can be obtained by measuring the electrical resistivity of the material.

A thin film strain gauge can be constructed by first depositing an electrical insulation layer, usually a ceramic onto the stressed metal surface, and then depositing a strain gauge material onto this insulation layer. Deposition techniques used to bond these materials can include vacuum deposition, chemical vapor deposition, physical vapor deposition, sputtering, other deposition techniques, or combinations thereof. Advantages of a thin-filmed strain gauge are that the deposited material is stable and less prone to measurement drifts than semiconductor strain gauges.

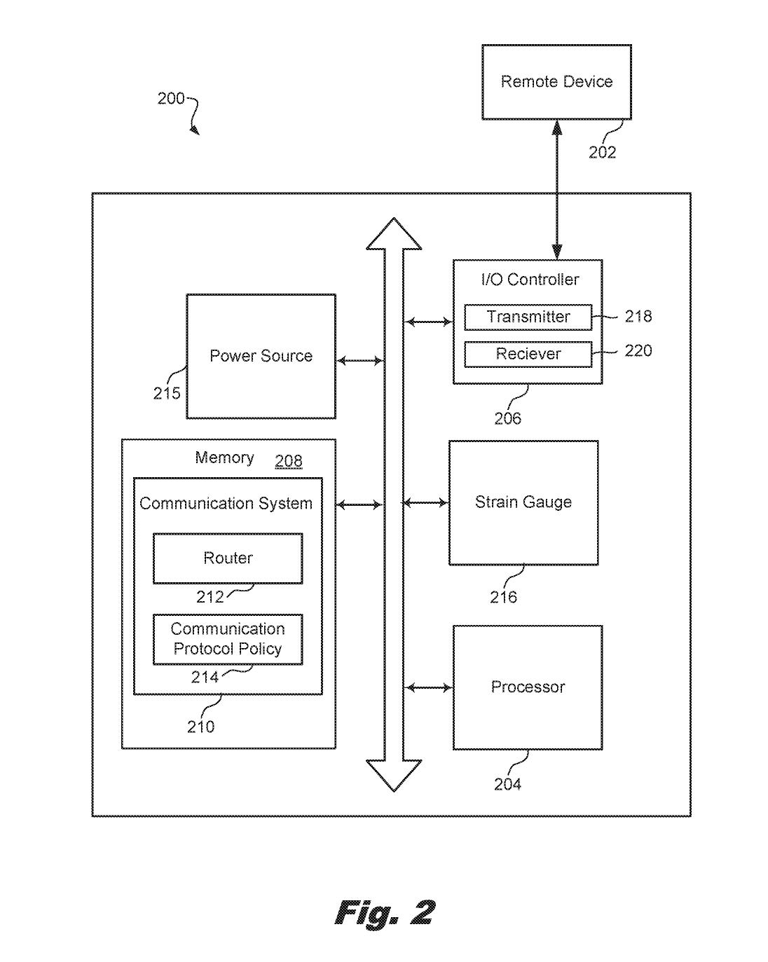

FIG. 2 shows a block diagram of the apparatus 200 in accordance with various aspects of the present disclosure. The apparatus 200 can include components for bi-directional data communications. For example, the user can communicate with the apparatus 200 through a remote device 202 or through an input mechanism built into the apparatus 200. Such built-in input mechanisms can include a microphone for voice commands, a touch screen, a button, a lever, a dial, a key board, a hand gesture camera, another type of input mechanism, or combinations thereof. The components that allow for communication can include a processor 204, I/O controller 206, and memory 208. Memory 208 can also include a communication system 210. The communication system 210 can include a router 212 and a communication protocol policy 214. The memory 208 can be in communication with a power source 215, and a strain gauge 216. In some cases, the I/O controller 206 includes transmitter 218 and a receiver 220. Additional components, such as magnetic shielding, can be included in the apparatus 200 to ensure that the magnetic field does not impact the accuracy of the data gathering and transmission.

The different functions of the communication system, the strain gauge, the power source, and other components of the apparatus can be implemented with a processor and programmed instructions in memory. In some examples, certain aspects of the apparatus' functions are executed with a customized circuit. Additionally, the different functions of the apparatus can be implemented with a processor and programmed instructions in memory. In some examples, the certain aspects of the apparatus' functions are executed with a customized circuit.

In some examples, the power source is a battery. In yet other examples, the power source includes a solar panel that harvests solar energy. In another embodiment, the power source harvests energy from the ambient environment, such as wind power, vibrations, wind energy, other types of energy, or combinations thereof

The processors can include an intelligent hardware device, (e.g., a general-purpose processor, a digital signal processor (DSP), a central processing unit (CPU), a microcontroller, an application specific integrated circuit (ASIC), a field-programmable gate array (FPGA), a programmable logic device, a discrete gate or transistor logic component, a discrete hardware component, or any combination thereof). In some cases, the processors can be configured to operate a memory array using a memory controller. In other cases, a memory controller can be integrated into the processor. The processor can be configured to execute computer-readable instructions stored in a memory to perform various functions.

An I/O controller can manage input and output signals for the apparatus. Input/output control components can also manage peripherals not integrated into these devices. In some cases, the input/output control component can represent a physical connection or port to an external peripheral. In some cases, I/O controller can utilize an operating system such as iOS®, ANDROID®, MS-DOS®, MS-WINDOWS®, OS/2®, UNIX®, LINUX®, or another known operating system.

Memory can include random access memory (RAM) and read only memory (ROM). The memory can store computer-readable, computer-executable software including instructions that, when executed, cause the processor to perform various functions described herein. In some cases, the memory can contain, among other things, a Basic Input-Output system (BIOS) which can control basic hardware and/or software operation such as the interaction with peripheral components or devices.

Information and signals described herein can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof

The various illustrative blocks and modules described in connection with the disclosure herein can be implemented or performed with a general-purpose processor, a DSP, an ASIC, a FPGA or other programmable logic device, discrete gate or transistor logic, discrete hardware components, or any combination thereof designed to perform the functions described herein. A general-purpose processor can be a microprocessor, but in the alternative, the processor can be any conventional processor, controller, microcontroller, or state machine. A processor can also be implemented as a combination of computing devices (e.g., a combination of a digital signal processor (DSP) and a microprocessor, multiple microprocessors, one or more microprocessors in conjunction with a DSP core, or any other such configuration).

The functions described herein can be implemented in hardware, software executed by a processor, firmware, or any combination thereof. If implemented in software executed by a processor, the functions can be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions can also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium can be any available medium that can be accessed by a general purpose or special purpose computer. By way of example, and not limitation, non-transitory computer-readable media can include RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. In some cases, the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. A portable medium, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

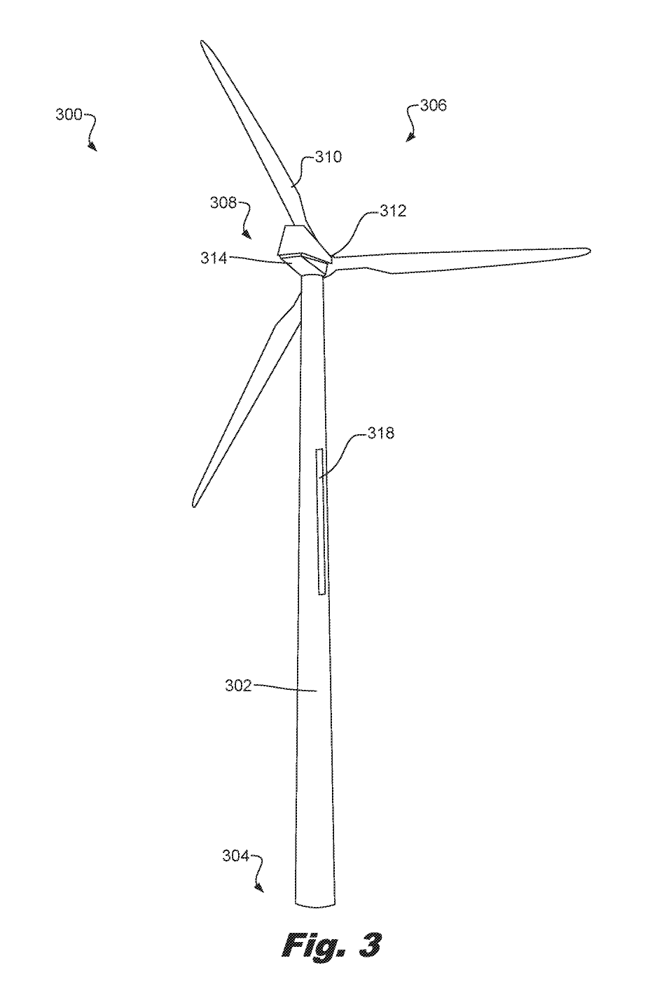

FIG. 3 illustrates an example of a wind tower 300. The tower 300 includes a tower body 302 connected to a foundation at a bottom end 304 and connected to a wind turbine 306 at a top end 308. The tower body 302 can be made of concrete, steel, metal, another material, or combinations thereof. The tower body 302 can have a monopole structure, a lattice structure, another type of structure, or combinations thereof. In this example, the tower body 302 has a continuously tapered side wall. But, in other examples, the tower can have at least one straight wall section or have uniform diameter along the tower body's entire length.

The wind turbine 306 can be a collection of components that convert the wind's kinetic energy into electric energy. These components can include rotor blades 310, a rotor 312, a nacelle 314, a drivetrain located in the nacelle 314, a gearbox located in the nacelle 316, a generator located in the nacelle 314 and/or in the tower body 302, an electrical system located in the nacelle 314 and/or in the tower body 302, controls, and other types of equipment used to convert the wind's kinetic energy into electric energy. The rotor 312 can include three blades 310, a hub, and a spinner. The blades 310 can have any appropriate length, but in some cases, the blades range from about 34.0 to 55.0 meters. Any appropriate type of material can be used to make the blades. Common materials for the blades include laminated materials, composites, balsa wood, carbon fiber, fiberglass, and other types of materials. The blades 310 can be constructed to generate lift, which causes the rotor 312 to turn in response to movement of the wind. The blades can be bolted onto the hub with a pitch mechanism interposed to allow the blades 310 to rotate about their rotational axis to take advantage of the varying wind speeds.

The nacelle 314 is a box-like component connected to the top of the tower body 302 and to the rotor 312. The nacelle 314 contains various components of the wind turbine, such as the gearbox, generator, main frame, other components, and so forth. The rotor drives a large shaft into a gearbox. The gearbox can step up the wind turbine blades' revolutions per minute to a rotary speed suitable for the electrical generator. Alternatively, the wind turbine can use a direct drive system in lieu of a gearbox. A direct drive system connects the rotor directly with the use of a permanent-magnet generator. A yaw drive system keeps the rotor facing the wind and to unwind the cables that travel down to the base of the tower. The yaw drive system often includes an electric or hydraulic system that rotates the rotor laterally to the desired azimuthal position that takes advantage of the wind.

In the illustrated example, the apparatus 318 is connected to the outer surface 320 of the tower body 302 with magnets. The apparatus 318 can measure the strain in the tower body 301 in the region of the tower body 302 that is within the distance between the first and second magnets of the apparatus 318. The strain measured within this subsection of the tower body 302 can be have a relationship with the strain experience throughout the tower body 302. In some examples, a strain measurement is obtained at different locations along the length of the tower body 302.

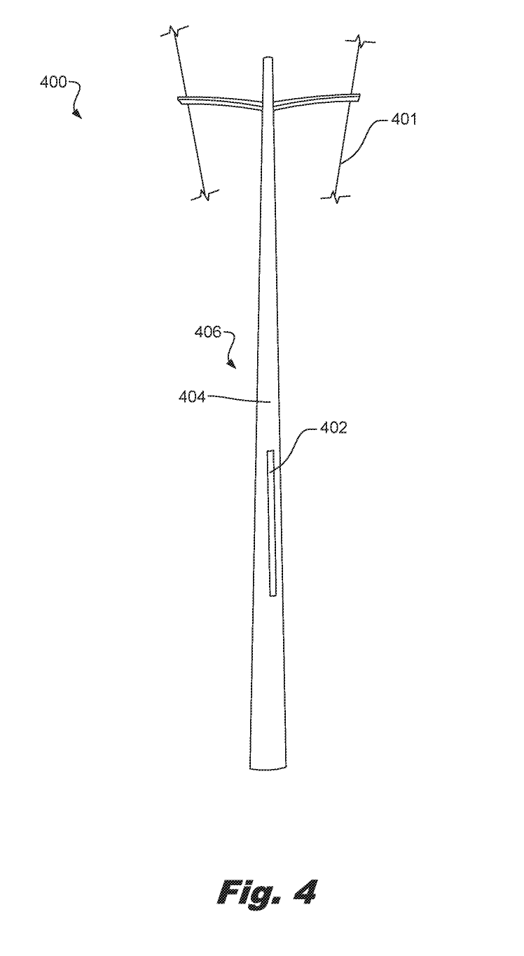

FIG. 4 illustrates an example of a utility line pole 400. In this example, the utility line pole 400 is a monopole that supports utility lines 401, such as telephone lines, power lines, other types of lines, or combinations thereof

In the illustrated example, the apparatus 402 is connected to the outer surface 404 of the utility line pole 400 with magnets. The strain measured within this subsection of the tower body 406 can be have a relationship with the strain experience throughout the tower body 406. In some examples, a strain measurement is obtained at different locations along the length of the tower body 406.

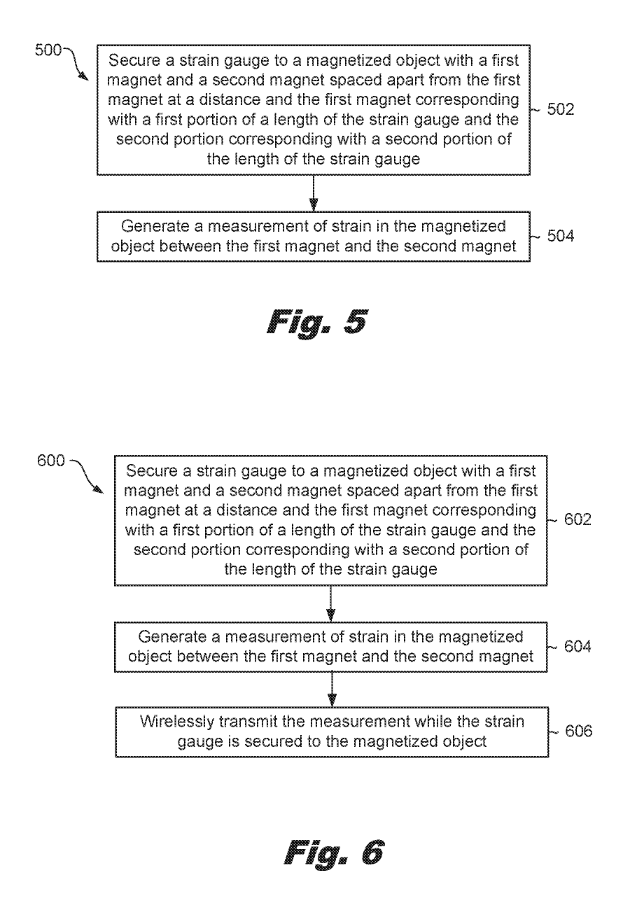

FIG. 5 depicts an example of a method 500 for obtaining a strain measurement. In this example, the method 500 includes securing 502 a strain gauge to a magnetized object with a first magnet and a second magnet spaced apart from the first magnet at a distance and the first magnet corresponding with a first portion of a length of the strain gauge and the second portion corresponding with a second portion of the length of the strain gauge, and generating 504 a measurement of strain in the magnetized object between the first magnet and the second magnet.

At block 502, a strain gauge can be connected to the magnetized object with a magnetic attachment that includes at least a first magnet and a second magnet. Attaching the strain gauge with magnets reduces the installation time and minimizes damage to the magnetized object.

At block 504, a strain measurement is generated. The strain measurement can be measured in response to a user inputting a command directly into the apparatus. In other examples, a command to generate a strain measurement can be generated in response to a command received wirelessly through a receiver. In yet another example, the apparatus is programmed to take a continuous strain measurement or take periodic sample strain measurements.

In some examples, the method can also include storing the measurements. The apparatus can include a memory where the measurements can be stored. In some cases, the measurements can be stored for a relatively short period where the measurements are stored long enough to prepare a transmission to send the measurements to a remote device. In other examples, the measurements are stored in a memory, such as a buffer, while a transmission is being prepared to send the measurement. After the measurement is sent, the measurement can be transferred from the buffer to a longer term memory in the apparatus. In some cases, the measurements are stored in this memory indefinitely or until deleted from the memory. Thus, the measurements can be stored locally, remotely, and/or both. In some cases, the measurements are stored locally until a request is made to send the measurements to a remote device.

The remote device can be operated by the manufacturer, a data center, a government office, a contractor's business, other entities, or combinations thereof. The remote device can include a mobile device, a laptop, a data center, a desk top, a server, a networked device, a database, remote memory, a cloud based device, another type of electronic device, or combinations thereof

The method can also include transmitting the measurement to the remote device. Transmitting the measurement can include sending raw data to a remote device. In other examples, the measurements can be sent as processed information. For example, some of the data can be compressed, filtered, modified, otherwise processed, or combinations thereof. Further, transmitting the measurements can include batch sending a number of measurements at a time, continuously sending the measurements as data is obtained, sending the measurements at intervals, or combinations thereof

In some examples, the method includes generating a strain inducing event in the magnetized object. For example in situations where the apparatus is connected to a wind turbine tower, the turbine blades can be stopped so that an increased amount of strain is felt along the length of the tower. In other examples, a brake or another type of resistance is applied to the rotation of the turbine blades to increase an amount of strain. In some examples, the pitch of the turbine blades, the direction that the turbine faces, or other parameters of the turbine, rotor, gearbox, generator, and so forth can be altered to induce a change in the strain experienced in the magnetized object. In some cases, the strain is recorded before, during, after, or combinations thereof with respect to triggering the strain inducing event. Other types of strain inducing events can include applying a load against a portion of the magnetized object, inducing a vibration in the magnetized object, inducing another type of strain inducing event, or combinations thereof

FIG. 6 depicts an example of a method 600 for obtaining a strain measurement. In this example, the method 600 includes securing 602 a strain gauge to a magnetized object with a first magnet and a second magnet spaced apart from the first magnet at a distance and the first magnet corresponding with a first portion of a length of the strain gauge and the second portion corresponding with a second portion of the length of the strain gauge, generating 604 a measurement of strain in the magnetized object between the first magnet and the second magnet, and wirelessly transmitting 606 the measurement while the strain gauge is secured to the magnetized object.

It should be noted that the methods described above describe possible implementations, and that the operations and the steps can be rearranged or otherwise modified and that other implementations are possible. Furthermore, aspects from two or more of the methods can be combined.

The description herein is provided to enable a person skilled in the art to make or use the disclosure. Various modifications to the disclosure will be readily apparent to those skilled in the art, and the generic principles defined herein can be applied to other variations without departing from the scope of the disclosure. Thus, the disclosure is not limited to the examples described herein, but is to be accorded the broadest scope consistent with the principles and novel features disclosed herein.

What is claimed is:

1. An apparatus, comprising:
a strain gauge; and
a magnetic attachment system connected to the strain gauge.

2. The apparatus of claim 1, wherein the magnetic attachment system comprises:
a first magnet;
a second magnet spaced apart from the first magnet at a distance;
wherein when the first magnet and the second magnet are magnetically attached to an object; and
wherein the strain gauge measures a mechanical strain in the object.

3. The apparatus of claim 1, wherein the magnetic attachment system comprises a rare earth metal.

4. The apparatus of claim 1, further comprising:
a housing;
a recess defined in the housing;
wherein the strain gauge is disposed within the recess.

5. The apparatus of claim 4, further comprising:
a handle attached to the housing.

6. The apparatus of claim 4, wherein the strain gauge further comprises:
a length;
a first portion of the length; and
a second portion of the length;
wherein the magnetic attachment system further includes:
a first magnet attached to the housing and corresponding to the first portion of the length of the strain gauge;
a second magnet attached to the housing and corresponding to the second portion of the length of the strain gauge;
the second magnet being spaced apart from the first magnet at a distance along the length of the strain gauge.

7. The apparatus of claim 1, further comprising:
a transmitter in electronic communication with the strain gauge.

8. The apparatus of claim 1, further comprising:
a receiver in electronic communication with the strain gauge.

9. The apparatus of claim 1, further comprising:
a router in electronic communication with the strain gauge.

10. The apparatus of claim 1, further comprising:
a power source in electronic communication with the strain gauge.

11. The apparatus of claim 1, further comprising:
a communication system in electronic communication with the strain gauge;
wherein the communication system operates on a standard communication protocol.

12. A method for using an apparatus, comprising:
securing a strain gauge to a magnetized object with a first magnet and a second magnet spaced apart from the first magnet at a distance and the first magnet corresponding with a first portion of a length of the strain gauge and the second magnet corresponding with a second portion of the length of the strain gauge; and
generating a measurement of strain in the magnetized object between the first magnet and the second magnet.

13. The method of claim 12, further comprising:
wirelessly transmitting the measurement while the strain gauge is secured to the magnetized object.

14. The method of claim 13, wherein wirelessly transmitting the measurement includes sending the measurement over a standard communication protocol.

15. The method of claim 12, wherein the magnetized object comprises a tower.

16. The method of claim 12, wherein the magnetized object comprises a monopole.

17. The method of claim 12, wherein the first magnet and the second magnet each comprise a rare earth metal.

18. The method of claim 12, wherein the first magnet and the second magnet each comprise permanent magnets.

19. The method of claim 12, wherein the measurement includes a less than 95 percent accurate representation of strain in the magnetized object between the first magnet and the second magnet.

20. An apparatus, comprising:
a housing;
a recess defined in the housing;
a strain gauge is disposed within the recess, where the strain gauge further includes:
a length;
a first portion of the length; and
a second portion of the length;
a magnetic attachment system connected to the housing, where the magnetic attachment system further includes:
a first magnet attached to the housing and corresponding to the first portion of the length of the strain gauge;
a second magnet attached to the housing and corresponding to the second portion of the length of the strain gauge;
the second magnet being spaced apart from the first magnet at a distance along the length of the strain gauge; and
a transmitter in electronic communication with the strain gauge.
